(19) United States
(12) Patent Application Publication
(10) Pub. No.: US 2007/0275694 A1
(43) Pub. Date: Nov. 29, 2007

(54) Controlling Communications Performed by an Information Processing Apparatus

(75) Inventors: Toru Aihara, Yokohama-shi (JP); Sanehiro Furuichi, Tokyo (JP); Masana Murase, Kawasaki-shi (JP)

Correspondence Address: MOLLBORN PATENTS;ATTN: IBM, 2840 COLBY DRIVE, BOULDER, CO, 80305, US

(73) Assignee: INTERNATIONAL BUSINESS MACHINES CORPORATION, Armonk, NY (US)

(21) Appl. No.: 11/682,422

(22) Filed: Mar. 6, 2007

(30) Foreign Application Priority Data
Apr. 6, 2006 (JP) JP2006-105044

(51) Int. Cl. H04M 1/66

(52) U.S. Cl. 455/410

(57) ABSTRACT

Methods and apparatus, including computer program products, implementing and using techniques controlling communication performed by a communication device in an information processing apparatus having an input device. An operation received by the input device is detected. A communication request directed to the communication device from a task executed by a central processing unit is detected. A relation is determined between the detected operation and the detected communication request. The communication performed by the communication device according to the communication request is prevented when there is no relation between the detected operation and the detected communication request.

### CROSS REFERENCE TO RELATED APPLICATIONS

The present application claims priority under 35 U.S.C. 119(a)-(d) from Japanese Patent Application No. JP2006-105044 entitled “METHOD AND PROGRAM FOR CONTROLLING COMMUNICATION PERFORMED BY INFORMATION PROCESSING APPARATUS” filed Apr. 6, 2006, the entire disclosure of which is incorporated herein by reference for all purposes.

### BACKGROUND

This invention relates to methods for controlling communication performed by information processing apparatuses. More specifically, the present invention relates to a method of preventing information leakage through communication.

Recently, malware has become more prevalent. The malware typically infiltrates information processing apparatuses, despite the intentions of users, and performs activities that the users do not desire. Spyware, which is one example of such malware, infiltrates an information processing apparatus, reads out information from a storage device, and transmits the information to external devices. If the spyware infiltrates the information processing apparatus, personal information or confidential information stored in the storage device may be stolen and misused by third parties, or may be disclosed to unspecified users.

Various types of security software have been developed that attempts to prevents the activities of such malware. Some examples of such security software include Spybot (http://www.spybot.info), AD-AWARE by Lavasoft (http://lavasoftusa.com), and Norton Personal Security 2005 by Symantec (http://www.symantec.com/region/jp/products/infp/features.html). The security software includes a list of signatures used for identifying executable files of malware. The signature may be, for example, a hash value generated from the executable file. The security software compares a suspicious executable file with the signatures in the list, and determines that the executable file is malware if the file matches a one or more signatures in the list. To cope with new malware that is continuously being developed, the signature list is regularly updated.

In addition, in the field of Internet banking, access to servers is commonly enabled by dedicated software that is distributed to customers. One example of such software includes the Anti-spyware measures using software keyboard, by Sony Bank (http://www.sonybank.net/img/PR050801_sb.pdf). This can prevent the activities of malware that gathers information through general-purpose software, such as a web browser. In addition, personal firewalls have recently been used to prevent leakage of personal information. Personal firewalls allow users to set application programs, communication protocols, port numbers, and target web sites for which the users permit communication.

Even in a case where a signature list of security software is regularly updated, it is difficult to completely prepare the signatures for all malware beforehand. For example, when the latest malware infiltrates an information processing apparatus before updating the signature list, it may be impossible to properly detect the infiltration of the malware. Furthermore, the malware may change its execution code. In such a case, the malware cannot be properly detected by only keeping the signature list in the latest state.

In addition, recently, malware that steals personal information from users of a P2P (peer to peer) system and discloses the information to third parties has become problematic, as discussed in Information about W32/Antinny.K, Symantec (http://www.symantec.com/region/jp/sarcj/data/w/w32.antinny.k.html). In the P2P system, users set a public folder to be disclosed to third parties. Files contained in the public folder are freely read out in response to requests of other users. A certain type of malware retrieves personal information of the user from the entire information processing apparatus, and stores the retrieved personal information in the public folder.

Such malware does not perform communication. Thus, sometimes information leakage cannot be prevented even using the personal firewall or dedicated software, since the software performing the communication is not the malware.

### SUMMARY

In general, in one aspect, the invention provides methods and apparatus, including computer program products, implementing and using techniques for controlling communication performed by a communication device in an information processing apparatus having an input device. An operation received by the input device is detected. A communication request directed to the communication device from a task executed by a central processing unit is detected. A relation is determined between the detected operation and the detected communication request. The communication performed by the communication device according to the communication request is prevented when there is no relation between the detected operation and the detected communication request.

The invention can be implemented to include one or more of the following advantages. It is possible to effectively prevent activities of malware that illegally takes data out by permitting the communication or disk access relating to the operation of the user. By using the elapsed time between the operation and the communication request and the relation between processes in combination to determine the relation, the accuracy of the determination can be increased. Such a function can be used instead of known antivirus software or in combination with the known antivirus software, which allows the effective prevention of activities of spyware. In addition, since the software that is less likely to perform illegal activities can be pre-registered, bothering the user for each disk access is eliminated, thus ensuring the user's convenience and the information security.

The details of one or more embodiments of the invention are set forth in the accompanying drawings and the description below. Other features and advantages of the invention will be apparent from the description and drawings, and from the claims.

### DESCRIPTION OF DRAWINGS

FIG. 1 shows a schematic overview of an information processing apparatus in accordance with one embodiment of the invention.

FIG. 2 shows an exemplary configuration of a hard disk drive in accordance with one embodiment of the invention.

FIG. 3 shows a functional configuration of a Central Processing Unit (CPU) in accordance with one embodiment of the invention.

FIG. 4. is a flowchart showing a process for detecting an operation performed on an input device in accordance with one embodiment of the invention.

FIG. 5 is a flowchart showing a process for controlling communication or access requested from a process in accordance with one embodiment of the invention.

FIG. 6 shows a detail of the processing performed at step S520 of FIG. 5 in accordance with one embodiment of the invention.

Like reference symbols in the various drawings indicate like elements.

### DETAILED DESCRIPTION

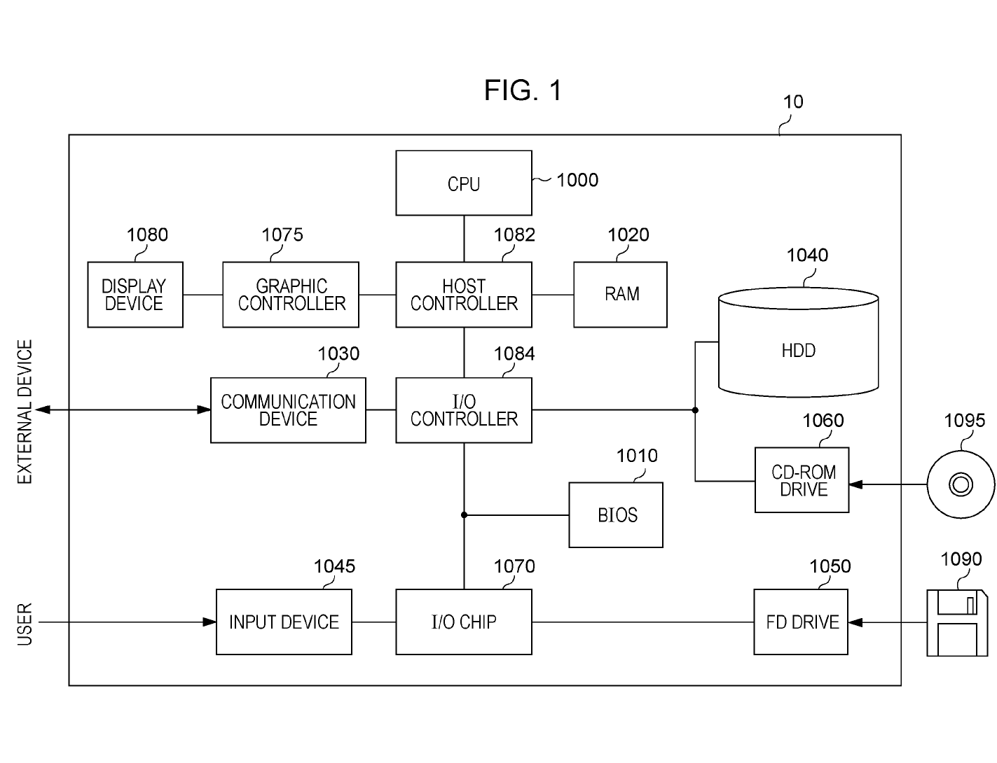

FIG. 1 shows a schematic overview of an information processing apparatus 10 in accordance with one embodiment of the invention. The information processing apparatus 10 includes a CPU (central processing unit) peripheral section, an input/output (I/O) section, and a legacy I/O section. The CPU peripheral section includes a CPU 1000, a RAM (random access memory) 1020, and a graphic controller 1075, which are connected with each other by a host controller 1082. The I/O section includes a communication device 1030, an input device 1045, a hard disk drive (HDD) 1040, and a CD-ROM (compact disc-read only memory) drive 1060, which are connected to the host controller 1082 by an I/O controller 1084. The legacy I/O section includes a BIOS (basic input output system) 1010, a flexible disk drive (FD drive) 1050, and an I/O chip 1070, which are connected to the I/O controller 1084.

The CPU 1000 and the graphic controller 1075 access the RAM 1020 at a high transfer rate. The host controller 1082 interconnects the RAM 1020, the CPU 1000, and the graphic controller 1075. The CPU 1000 works on the basis of programs stored in the BIOS 1010 and the RAM 1020, and controls each part. The graphic controller 1075 acquires image data generated by the CPU 1000 or the like in a frame buffer provided in the RAM 1020, and causes a display device 1080 to display images corresponding to the image data. The display device 1080 displays results of operations executed by the CPU 1000. More specifically, the display device 1080 may display several windows, each displaying the operation results and each receiving user operations, in order to realize a multi-window system.

The I/O controller 1084 interconnects the host controller 1082 and relatively high-speed I/O devices, such as the communication device 1030, the HDD 1040, the input device 1045, and the CD-ROM drive 1060. The communication device 1030 communicates with external devices via a network. The HDD 1040 is an example of a storage device employed in an embodiment of the present invention, and stores programs and data used by the information processing apparatus 10. The input device 1045 informs the I/O chip 1070 of content of operations received thereby. For example, the input device 1045 may be a keyboard or a mouse, and may inform the I/O chip 1070 of an ID of the pressed key or an ID of the clicked button of the mouse. The CD-ROM drive 1060 reads programs or data from a CD-ROM 1095, and supplies the programs or data to the RAM 1020 or the HDD 1040.

The BIOS 1010 and relatively low-speed I/O devices, such as the FD drive 1050 and the I/O chip 1070, are connected to the I/O controller 1084. The BIOS 1010 stores a boot program executed by the CPU 1000 at the time of booting of the information processing apparatus 10 and hardware-dependent programs that are dependent on the hardware of the information processing apparatus 10. The FD drive 1050 reads programs or data from a flexible disk 1090, and supplies the programs or data to the RAM 1020 or the HDD 1040 through the I/O chip 1070.

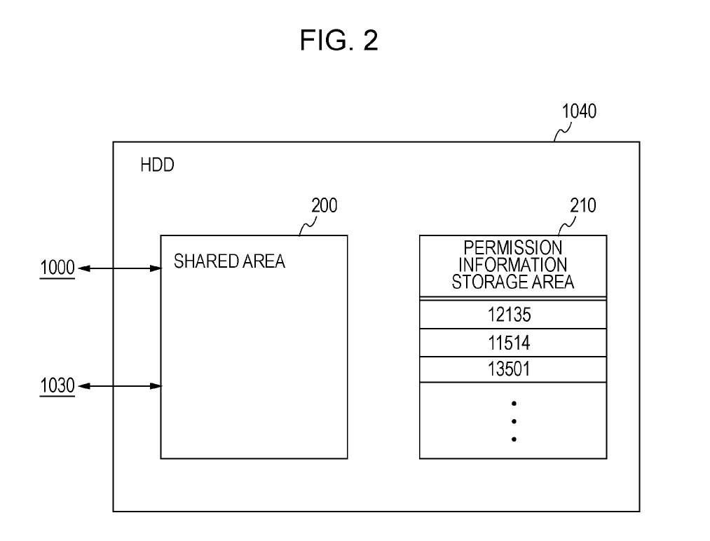

Programs are stored on a storage medium, such as the flexible disk 1090, the CD-ROM 1095, or an IC (integrated circuit) card, and supplied to the information processing apparatus 10 by users. The programs are read out from the storage medium through the I/O chip 1070 and/or the I/O controller 1084, and installed in the information processing apparatus 10, and are executed. Operations that the programs cause the information processing apparatus 10 or the like to execute will be described with reference to FIGS. 2 to 6.

The programs described above may be stored on external storage media. The storage media can include the flexible disk 1090, the CD-ROM 1095, an optical storage medium such as DVD (digital versatile disk) or a PD (phase change rewritable disk), a magneto-optical storage medium such as an MD (minidisk), a tape medium, and a semiconductor memory such as an IC card. In addition, the programs may be supplied to the information processing apparatus 10 via a network using a storage device, such as an HDD or a RAM, provided in a server system connected to a private communication network or the Internet as the storage medium.

FIG. 2 shows an example of a configuration of the HDD 1040. The HDD 1040 includes a shared area 200 and a permission information storage area 210. The shared area 200 is configured so that data can be exchanged between the information processing apparatus 10 and other information processing apparatuses. For example, the shared area 200 is accessed by processes running on the CPU 1000. In addition, the shared area 200 is also accessed by other external information processing apparatuses through the communication device 1030. For example, the shared area 200 may be an area that is made accessible by other information processing apparatuses using a folder sharing function of Windows®. Alternatively, the shared area 200 may be configured to be accessible from an unspecified large number of information processing apparatuses by P2P (peer to peer) software (e.g., Winny). That is, data stored in the shared area 200 can be transmitted to other information processing apparatuses managed by other users without an explicit communication instruction given by the user of the information processing apparatus 10.

The permission information storage area 210 serves as a permission information storage section employed in an embodiment of the present invention. The permission information storage area 210 stores identification information of processes having permission to communicate, using the communication device 1030, regardless of the relation to the operations received by the input device 1045. In addition, the permission information storage area 210 stores identification information of processes permitted to access the HDD 1040, regardless of the relation to the operations received by the input device 1045. That is, a controller 350, which will be described in further detail below, permits communication according to a communication request issued by the process whose identification information is stored in the permission information storage area 210. Similarly, the controller 350 permits access according to an access request issued by the process having the identification information stored in the permission information storage area 210. Here, preferably, the identification information of the process may be, for example, a hash value of binary data of a program, executed by the process, stored in an executable file. Alternatively, the identification information of the process may be, for example, a process ID, a path of an executable file for executing the process, or a command (including an option given to the command) causing execution of the executable file. Users can exclude processes from targets of unauthorized access detection by storing the identification information of the trusted processes in the permission information storage area 210.

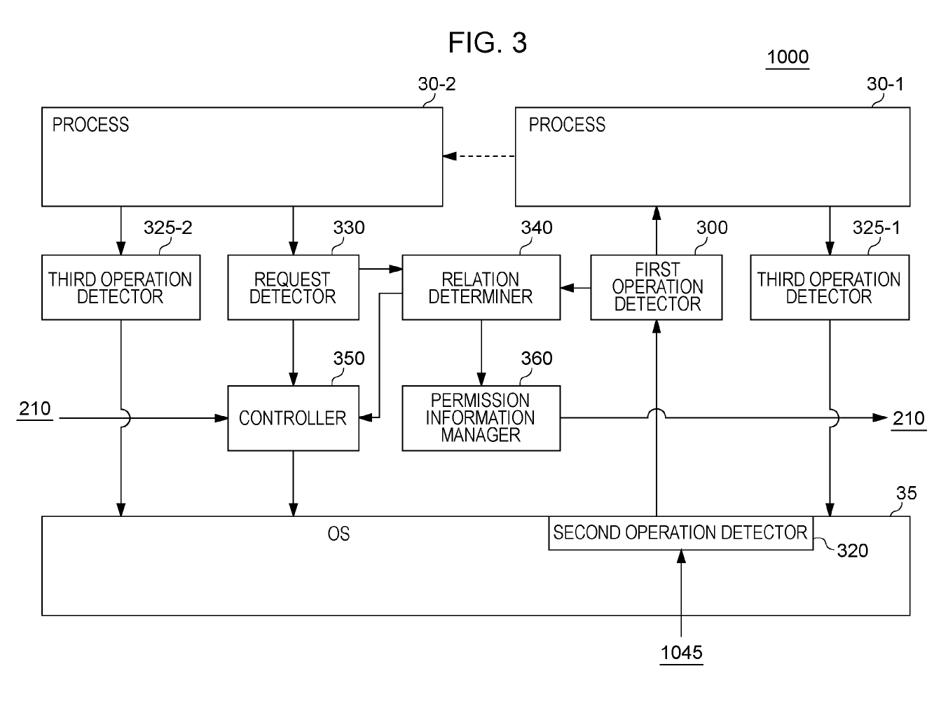

FIG. 3 shows a functional configuration of the CPU 1000. The CPU 1000 functions as processes 30-1 and 30-2, an operating system (OS) 35, a first operation detector 300, a second operation detector 320, third operation detectors 325-1 to 2, a request detector 330, a relation determiner 340, the controller 350, a permission information manager 360 by means of programs having been installed in the HDD 1040 or the like. The process 30-1 is an example of a first task according to an embodiment of the present invention. The process 30-1 receives messages, indicating the contents of the operations received by the input device 1045, from the OS 35. The process 30-2 is an example of a second task according to an embodiment of the present invention, and transmits communication requests to the communication device 1030 through the OS 35. In addition, the processes 30-1 to 2 may perform inter-process communication. Additionally, each of the tasks according to the embodiment of the present invention is not necessarily the process, and may be a thread. Although FIG. 3 shows the processes 30-1 and 30-2 as individual processes, the processes 30-1 and 30-2 may be the same process.

In one embodiment, the first operation detector 300, the second operation detector 320, and the third operation detectors 325-1 to 2 serve as operation detecting sections and detect operations received by the input device 1045. The operations may be, for example, a key input operation performed on a keyboard and a click or drag-and-drop operation performed on a mouse. More specifically, the first operation detector 300 works in a memory space in which the process 30-1 works, and is realized by hooking the messages, which indicate contents of the operations that the input device 1045 has received, transferred to the process 30-1 from the OS 35. The messages indicating the operation contents include, for example in Windows®, WM_KEYDOWN indicating pressing of a key of a keyboard corresponding to the input device 1045, and WM_LBUTTONDOWN indicating pressing of a left button of the mouse, which is the input device 1045.

The first operation detector 300 starts working when these messages are transmitted from the OS 35 to the process 30-1. After starting working, the first operation detector 300 causes the second operation detector 320 to verify whether the input device 1045 is actually operated by the user. The second operation detector 320 is realized by a device driver that works in a kernel space. The second operation detector 320 detects whether the user actually has operated the input device 1045 when the messages, indicating the contents of the operations received by the input device 1045, are transmitted from the OS 35 to the process 30-1. For example, the second operation detector 320 determines that the input device 1045 has not been operated when a key operation emulation is performed by a virtual keyboard device driver. To realize this, the second operation detector 320 detects, for example, other device drivers belonging in the same layer as the device driver for the input device 1045, such as a keyboard and a mouse. The second operation detector 320 determines that the input device 1045 has not been operated when the detected device driver is not the predetermined proper device driver. As described above, it may be possible to increase the accuracy of the operation detection by checking the device driver layer.

Alternatively, the first operation detector 300 and the second operation detector 320 may determine that the input device 1045 has been operated if the elapsed time, from the input device 1045 receiving the operation until one of the processes receiving the content of the operation, is equal to or shorter than a reference period. More specifically, the second operation detector 320 first stores the time at which the input device 1045 is actually operated in a storage device. The first operation detector 300 then calculates a time difference between the time at which the process 30-1 receives the message indicating the content of the operation and the time stored in the storage device, and thereby measures the elapsed time between these time points. The first operation detector 300 and the second operation detector 320 then determine that the input device 1045 has received the operation if the measured time period is equal to or shorter than the reference period. By means of this procedure, regardless of the fabrication of the messages, only the contents of the operations likely to be actually received can be transmitted as a message to the process, thus it is possible to accurately determine whether the communication or the access relates to the user operation.

The second operation detector 320 determines that the input device 1045 has not been operated when the process 30-1 receives the message indicating the operation content but the input device 1045 has not received the operation. For example, when the virtual keyboard device driver, which by software emulates the operation performed on a keyboard, transmits the message to the process 30-1, the second operation detector 320 determines that the input device 1045 has not received the operation. When the input device 1045 is determined to have received the operation, the first operation detector 300 transmits the message indicating the operation content to the process 30-1 without any change. The first operation detector 300 also informs the relation determiner 340 of information such as the message reception time.

The third operation detector 325-1 is provided for the process 30-1, and the third operation detector 325-2 is provided for the process 30-2. Each of the third operation detectors 325-1 to 2 works when a key operation emulation request is transmitted to the OS 35 from the corresponding process. Each of the third operation detectors 325-1 to 2 is realized by hooking APIs (application programming interfaces) requesting the OS 35 to emulate the key operation transmitted from the corresponding process. This is realized by, for example, hooking a function for emulating the key operation, such as a SendInput function in Windows®, and by confirming the function is not called. Upon detecting the key operation emulation request to the OS 35, each of the third operation detectors 325-1 to 2 cancels the key operation emulation request (fails the API call). However, such a request may be permitted only to a predetermined process that realizes remote operations. That is, each of the third operation detectors 325-1 to 2 may determine that the input device 1045 has received the operation when the operation content is supplied to another process on the basis of the operation of the predetermined process that remotely operates the information processing apparatus 10 even if the input device 1045 has not been operated.

The request detector 330, the relation determiner 340, the controller 350, and the permission information manager 360 work in the same memory space as the process 30-2. The request detector 330 detects communication requests given to the communication device 1030 from one of the processes (e.g., the process 30-2) executed by the CPU 1000. The request detector 330 also detects access requests to the HDD 1040 from one of the processes (e.g., the process 30-2) executed by the CPU 1000. More specifically, the request detector 330 is realized by hooking APIs used by the process 30-2 to send the communication requests and APIs used by the process 30-1 to send the access requests. The APIs used for sending the communication requests include, for example in Windows®, “sendto” for requesting data transmission according to UDP (user datagram protocol), “send” for requesting data transmission according to TCP (transmission control protocol), “recv” for requesting data reception according to TCP, and “recvfrom” for requesting data reception according to UDP. The APIs used for sending the access requests include, for example in Windows®, “ReadFile” for requesting reading of data from a file and “CreateFile” for requesting newly creating a file.

The relation determiner 340 determines a relation between the operation detected by the first operation detector 300 and the communication request detected by the request detector 330. The relation determiner 340 also determines the relation between the operation that the first operation determiner 300 has detected and the access request that the request detector 330 has detected. For example, the relation determiner 340 may determine the detected operation and the detected communication request are related to each other if the period from the input device 1045 receiving the operation until the communication device 1030 receiving the communication request is shorter than a predetermined reference period. Similarly, the relation determiner 340 may determine that the detected operation is related to the detected access request if the period from the input device 1045 receiving the operation until the HDD 1040 receiving the access request is shorter than the reference period.

The relation determiner 340 may further determine the relation between the detected operation and the detected communication request or access request on the basis of the relation between the processes 30-1 and 30-2. More specifically, the relation determiner 340 may determine that the detected operation is related to the detected communication request or access request on the further condition that the processes 30-1 and 30-2 are the same. Furthermore, the relation determiner 340 may determine that the detected operation and the detected communication request are related to each other if the process 30-1 directly or indirectly communicates with the process 30-2. Here, a state in which “the process 30-1 indirectly communicates with the process 30-2” is referred to as a case where the process 30-1 communicates with a mediation process, and the mediation process communicates with the process 30-2. There may be several mediation processes. As another example, the relation determiner 340 may determine that the detected operation and the detected communication request or access request are related if ancestor processes that have directly or indirectly generated the processes 30-1 and 30-2 are the same. Here, “directly or indirectly generating a process” means generating the process as a child process or generating a child process that further generates a descendant process, i.e., the process. For example, the relation determiner 340 may determine that the detected operation is related to the detected communication request or access request if both processes 30-1 and 30-2 are generated by a common parent process.

The controller 350 prevents communication performed by the communication device 1030 according to the communication request if there is no relation between the operation detected by the first operation detector 300 and the second operation detector 320 and the communication request detected by the request detector 330. The controller 350 permits the communication according to the communication request if the detected operation and the detected communication request are related. Similarly, the controller 350 prevents access to the HDD 1040 according to the access request if the operation detected by the first operation detector 300 and the second operation detector 320 is unrelated to the access request detected by the request detector 330. The controller 350 permits the access according to the access request, if the detected operation and the detected access request are related to each other. More specifically, if the relation is determined to exist, the controller 350 causes the request detector 330 to execute the hooked API without any change.

The controller 350 permits the communication or the access based on the communication request or the access request issued by the process whose identification information is stored in the permission information storage area 210 regardless of the relation to the operation. In addition, the controller 350 may inquire of the user of the information processing apparatus 10 whether to permit the communication or the access, when the controller 350 prevents the communication or the access due to the lack of a relation between the operation and the request. The inquiry may be performed by, for example, displaying a dialog box on a screen of the display device 1080. The dialog box shows a message alerting the user together with buttons for indicating permission and prevention of the communication. The message may say “communication highly likely to be unauthorized is requested by the process XX. Do you permit this communication?” Using this configuration, it is possible to ask the user to make a determination regarding a communication that may be highly possibly unauthorized, and to prevent leakage of confidential information and personal information.

The permission information manager 360 stores identification information of the process having issued the communication request or the access request in the permission information storage area 210, when the relation determiner 340 determines the operation is related to the communication request or the access request. As a result, once a process has been determined to have performed access relating to the operation, the process can freely perform subsequent communication or access. By means of this configuration, the load of the CPU 1000 and the operation load of the user through the dialog box can be reduced by omitting the above determination for processes less likely to perform unauthorized operations.

As described above, an example of determining a relation between the operation received by the process 30-1 and the communication request issued by the process 30-2 has been described with reference to FIG. 3. However, one of the processes 30-1 and 30-2 may have the function of the other one. That is, the process 30-1 may not only receive the operation but also issue the communication request. Similarly, the process 30-2 may not only issue the communication request but also receive the operation. In such a case, another first operation detector may be provided for the process 30-2 separate from the first operation detector 300. In addition, another request detector, another relation determiner, another controller, and another permission information manager may be provided for the process 30-1 separate from the request detector 330, the relation determiner 340, the controller 350, and the permission information manager 360. It is obvious that such an embodiment is also included in the scope of the claims of the present invention.

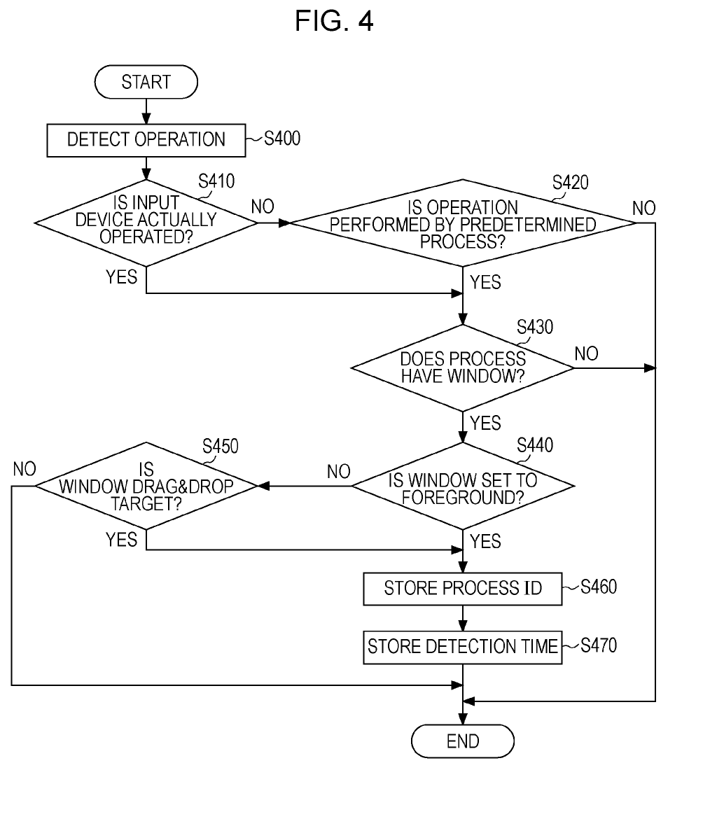

FIG. 4 shows a flowchart for detecting an operation performed on the input device 1045. The first operation detector 300 detects an operation received by the input device 1045 (step S400). The first operation detector 300 may not detect all of the operations performed on the input device 1045, but only a predetermined operation. The predetermined operation may be that for instructing a process, such as the process 30-1, to start processing based on the input. For example, the predetermined operation may be an input operation of an enter key performed on a character input field shown in the display device 1080. As another example, the predetermined operation may be a double clicking operation of a mouse performed for an icon displayed on the display device 1080, or an operation of a predetermined shortcut key. Detecting only a specific operation like this can reduce the number of times that the processing performed thereafter in response to the detection of the operation, thus decreasing the processing load of the CPU 1000.

The first operation detector 300, the second operation detector 320, and each of the third operation detectors 325-1 to 2 determine whether the detected operation is occurred not because the process 30-1 only receives a message indicating the operation content but because the input device 1045 is directly operated (step S410). If the input device 1045 is not directly operated, the first operation detector 300, the second operation detector 320, and the third operation detectors 325-1 to 2 determine whether or not the message is input from a predetermined process that controls the remote operation of the information processing apparatus 10 (step S420). The predetermined process that controls the remote operation may be a process that transmits images of display screens of the information processing apparatus 10 to other information processing apparatus and that transmits messages indicating the contents of the operation that the other information processing apparatuses have received to a process of the information processing apparatus 10. For example, in Windows®, the predetermined process is a process that realizes a terminal server function, and the name of the executable file of the process is “svchost.exe”.

If the input device 1045 is not directly operated and the message indicating the operation content is not input from the predetermined process, the first operation detector 300, the second operation detector 320, and the third operation detectors 352-1 to 2 terminate the processing shown in this figure. At this time, the third operation detectors 325-1 to 2 may cancel the request, such as key input emulation, and may fail the API call realizing such a request. On the other hand, if the input device 1045 is directly operated or the message indicating the operation content is input from the predetermined process, the first operation detector 300, the second operation detector 320, and the third operation detectors 325-1 to 2 continuously perform the following processing. First, the first operation detector 300 determines whether one of the windows displayed on the screen of the display device 1080 belongs to the process (i.e., the process 30-1) that receives the message (step S430). This window is used by the process 30-1 for displaying the processing result or for receiving the input to the process 30-1.

If the process 30-1 has the window, the first operation detector 300 determines whether the window is set to the foreground at the time that the input device 1045 received the operation (step S440). The foreground window means, for example, a window that is displayed in the foreground such that the foreground window covers other windows displayed on the screen of the display device 1080. If the window is not set as the foreground, the first operation detector 300 determines whether the window is at the target of the drag-and-drop operation of the mouse, which is the input device 1045 (step S450). If the window is not set to the foreground and is not at the target of the drag-and-drop operation, the first operation detector 300 terminates the processing shown in FIG. 4.

On the other hand, if the window is set to the foreground or the window is at the target of the drag-and-drop operation, the first operation detector 300 performs the following processing to detect the operation that the input device 1045 has received. First, the first operation detector 300 stores identification information of the process (e.g., the process 30-1) that has received the message indicating the operation content in the temporary storage area (step S460). The identification information is used to determine a relation between processes at step S650, which is described below. The first operation detector 300 then stores the detection time of the operation received by the input device 1045 in the temporary storage area (step S470). The detection time is used for the calculation of the elapsed time at step S630, which is described below.

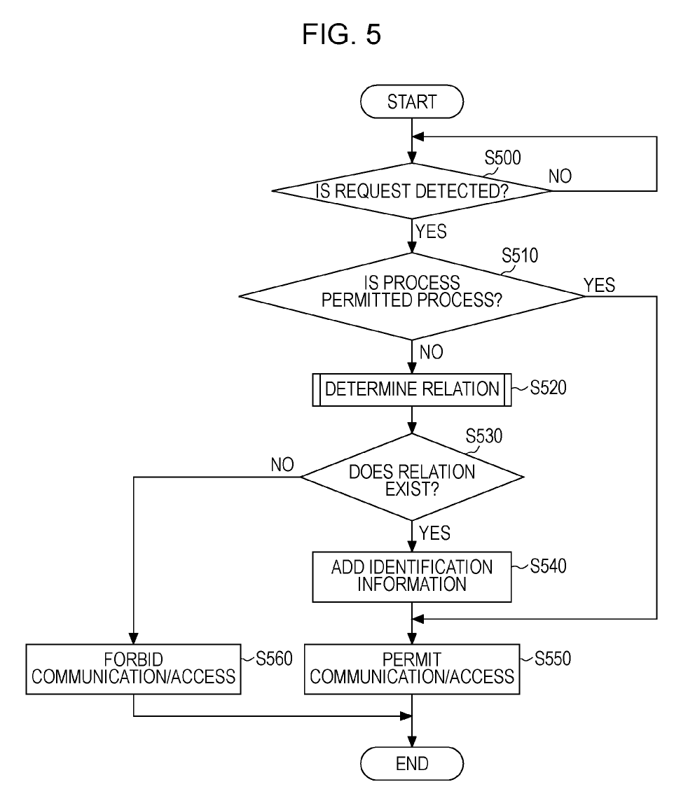

FIG. 5 shows a flowchart of processing for controlling the communication or the access requested from the process. The request detector 330 detects the communication request directed to the communication device 1030 from one of the processes (e.g., the process 30-2) executed by the CPU 1000 or the access request to the HDD 1040 from the process 30-2 (step S500). In response to the detection of the communication request or the access request, the controller 350 determines whether the process that has issued these requests is the process permitted for the communication or access beforehand (step S510). This determination is performed depending on whether the identification information of the process is stored in the permission information storage area 210. If the process is the permitted process, the controller 350 proceeds to step S550, and permits the communication or the access.

In the event that the process is not permitted for the communication or the access, the relation determiner 340 performs the following processing. First, the relation determiner 340 determines the relation between the operation detected at step S400 and the communication or access request detected at step S500 (step S520). If there is no relation, the controller 350 prevents communication according to the communication request or the access to the HDD 1040 according to the access request (step S560). Before this step, the controller 350 may inquire of the user whether to prevent the communication or the access, and may prevent the communication or the access under the agreement of the user. When preventing the communication or the access, the controller 350 may further issue a warning to the user, may terminate the API for transmitting the communication request in a failure state, or may abort the process that has issued the communication request. In addition to this, the controller 350 may delete the executable file of the process from the HDD 1040.

On the other hand, if the relation exists, the permission information manager 360 stores the identification information of the process having issued the communication request or the access request in the permission information storage area 210 (step S540). The controller 350 then permits the communication or the access performed by the process (step S550).

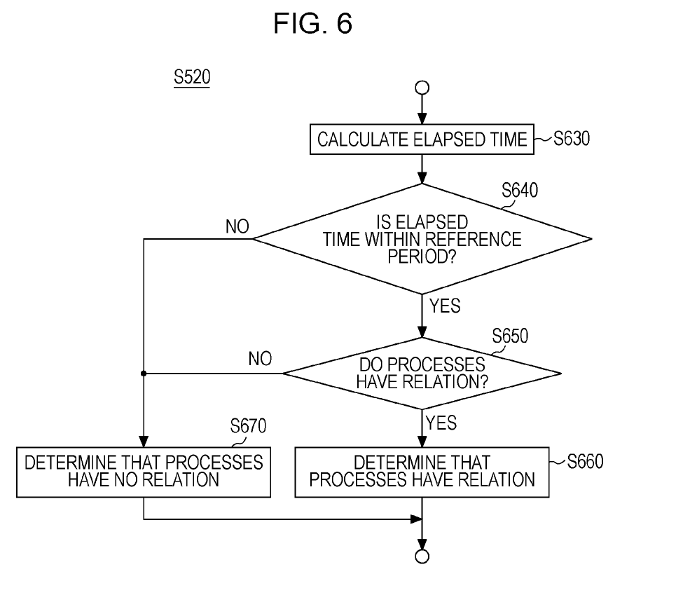

FIG. 6 shows a detailed view of the processing performed at step S520 of FIG. 5. The relation determiner 340 calculates the elapsed period from the detection of the operation at step S400 until the detection of the request at step S500 (step S630). The relation determiner 340 then determines whether the calculated period is equal to or shorter than the predetermined reference period (step S640). If the calculated period is not within the reference period, the relation determiner 340 determines that the detected operation and the detected request are unrelated (step S670). On the other hand, if the calculated period is within the reference period, the relation determiner 340 determines whether the process 30-1 that receives the message indicating the operation content and the process 30-2 issuing the request are related (step S650).

For example, the relation determiner 340 may determine whether the processes 30-1 and 30-2 are the same process, or whether the process 30-1 directly or indirectly communicates with the process 30-2. Furthermore, the relation determiner 340 may determine whether both processes 30-1 and 30-2 are generated by a common parent process. If the process 30-1 is related to the process 30-2, the relation determiner 340 determines that the detected operation is related to the detected request (step S660). On the other hand, if the process 30-1 is not related to the process 30-2, the relation determiner 340 determines that the detected operation and the detected request are unrelated (step S670).

As described above with reference to FIGS. 1 to 6, the information processing apparatus 10 according to the embodiments of the present invention can effectively prevent activities of malware that illegally takes data out by permitting the communication or disk access relating to the operation of the user. By using the elapsed time between the operation and the communication request and the relation between processes in combination to determine the relation, the accuracy of the determination can be increased. Such a function can be used instead of known antivirus software or in combination with the known antivirus software, which allows the effective prevention of activities of spyware. In addition, since the software that is less likely to perform illegal activities can be pre-registered, bothering the user for each disk access is eliminated, thus ensuring the user's convenience and the information security.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

Although the present invention has been described using exemplary embodiments, the technical scope of the present invention is not limited to the scope described in the above embodiments. It is obvious for those skilled in the art that various modifications or improvements can be added to the above-described embodiments. It is obvious from the appended claims that such modifications or improvements can be also included within the technical scope of the present invention.

1. An information processing apparatus, comprising:
an input device;
a communication device;
an operation detector operable to detect an operation received by the input device;
a request detector operable to detect a communication request directed to the communication device from a task executed by a central processing unit;
a relation determiner operable to determine a relation between the detected operation and the detected communication request; and
a controller operable to prevent the communication performed by the communication device according to the communication request when there is no relation between the detected operation and the detected communication request.

2. The information processing apparatus of claim 1, further comprising:
a storage device operable to enable data exchange between the information processing apparatus and another apparatus,
wherein:
the request detector is further operable to detect an access request to the storage device from a task executed by the central processing unit,
the relation determiner further is operable to determine a relation between the detected operation and the detected access request, and
the controller is operable to prevent access to the storage device according to the access request when there is no relation between the detected operation and the detected access request.

3. The information processing apparatus of claim 1, wherein
the relation determiner is operable to determine that the detected operation is related to the detected communication request when a period, from the input device receiving the operation until the communication device receiving the communication request, is shorter than a predetermined reference period.

4. The information processing apparatus of claim 1, wherein
the central processing unit executes a first task operable to receive content of the operation received by the input device from an operating system and a second task operable to transmit the communication request to the communication device through the operating system, and
the relation determiner is operable to determine a relation between the detected operation and the detected communication request based on a relation between the first task and the second task.

5. The information processing apparatus of claim 4, wherein
the relation determiner is operable to determine that the detected operation is related to the detected communication request when the first task and the second task are the same.

6. The information processing apparatus of claim 4, wherein
the relation determiner is operable to determine that the detected operation is related to the detected communication request when the first task is communicating directly or indirectly with the second task.

7. The information processing apparatus of claim 4, wherein
the relation determiner is operable to determine that the detected operation is related to the detected communication request when an ancestor task having directly or indirectly generated the first task is the same as an ancestor task having directly or indirectly generated the second task.

8. The information processing apparatus of claim 4, further comprising:
a display unit operable to display a window that shows a processing result or accepts an input of an operation, wherein
the relation determiner is operable to determine that the detected operation is related to the detected communication request when the foreground window at the time of acceptance of the operation belongs to the first task.

9. The information processing apparatus of claim 4, wherein
the input device is a mouse and the operation detector is operable to detect a drag-and-drop operation of the mouse, and
the relation determiner is operable to determine that the detected operation is related to the detected communication request when the window at the target of the drag-and-drop operation belongs to the task acquiring the content of the operation received by the input device.

10. The information processing apparatus of claim 1, further comprising:
a permission information storage unit operable to store identification information of a task permitted to perform the communication using the communication device regardless of the relation to the operation, wherein
the controller is operable to permit the communication according to the communication request issued by the task whose identification information is stored in the permission information storage unit.

11. The information processing apparatus of claim 10, further comprising:
a permission information manager operable to add identification information of a task having issued the communication request in the permission information storage unit in response to the determination that the operation relates to the communication request performed by the relation determiner.

12. The information processing apparatus of claim 1, wherein
the operation detector is operable to determine that the input device has not been operated when the content of the operation is received by one of the tasks without the input device receiving the operation.

13. The information processing apparatus of claim 12, wherein
the operation detector is operable to determine, when another task receives the content of the operation in response to the processing of a predetermined task that controls a remote operation of the information processing apparatus, that the input device is operated even if the input device does not receive the operation.

14. The information processing apparatus of claim 1, wherein
the operation detector is operable to determine that the input device is operated when an elapsed time period, from the input device receiving the operation and until one of the tasks receiving the content of the operation, is equal to or shorter than a predetermined reference period.

15. The information processing apparatus of claim 1, wherein
the operation detector is operable to detect a predetermined operation for instructing a task to start processing based on the input,
the relation determiner is operable to determine a relation between the predetermined operation and the communication request, and
the controller is operable to prevent the communication performed by the communication device according to the communication request when there is no relation between the predetermined operation and the detected communication request.

16. A method for controlling communication performed by a communication device in an information processing apparatus having an input device, the method comprising:
detecting an operation received by the input device;
detecting a communication request directed to the communication device from a task executed by a central processing unit;
determining a relation between the detected operation and the detected communication request; and
preventing the communication performed by the communication device according to the communication request when there is no relation between the detected operation and the detected communication request.

17. A computer program product comprising a computer useable medium including a computer readable program, wherein the computer readable program when executed on a computer causes the computer to:
detect an operation received by the input device;
detect a communication request directed to the communication device from a task executed by a central processing unit;
determine a relation between the detected operation and the detected communication request; and
prevent the communication performed by the communication device according to the communication request when there is no relation between the detected operation and the detected communication request.
